(19) United States
(12) Patent Application Publication
(10) Pub. No.: US 2001/0028434 A1
(43) Pub. Date: Oct. 11, 2001

(54) Bifocal contact lens

(76) Inventor: William Carter, Reedley, CA (US)

Correspondence Address: OPPENHEIMER WOLFF & DONNELLY LLP, Suite 3800, 2029 Century Park East, Los Angeles, CA, 90067, US

(21) Appl. No.: 09/879,693

(22) Filed: Jun. 12, 2001

Related U.S. Application Data
(63) Continuation-in-part of application No. 09/414,743, filed on Oct. 8, 1999.
(60) Provisional application No. 60/103,538, filed on Oct. 8, 1998.

(51) Int. Cl. G02C 7/02; G02C 7/04

(52) U.S. Cl. 351/161; 351/159

(57) ABSTRACT

A monocentric bifocal contact lens for use on the cornea of an eye has a rear surface adapted to overlie the cornea of the eye in use. The rear surface typically has a substantially constant radius of curvature. The lens has a front surface that is subdivided into distant vision and near vision portions. The major portion of the lens is defined by upper and lower circles of substantially equal diameter, the respective centers of each of the two circles lying along a common vertical line. An upper portion of the lower circle overlaps a lower portion of the upper circle, with the near-vision portion of the lens being substantially defined by the overlapping portion of the two circles. The lower circle has an upper edge that extends upwardly along the lens to a point no more than one-half the diameter of the upper circle. The near vision portion of the lens extends entirely within the lower half of the lens and occupies less than one-half the surface area of the lens.

### RELATED APPLICATIONS

This is a continuation-in-part of U.S. patent application Ser. No. 09/414,743, which was filed on Oct. 8, 1999 and which claimed the benefit of U.S. Provisional Patent Application Serial No. 60/103,538, filed on Oct. 8, 1998.

### PRIOR ART

Examples of prior art bifocal contact lenses are illustrated in U.S. Pat. Nos. 4,693,572, 5,743,159, 5,371,976, and 5,296,880, all of which are incorporated by reference herein. These prior art lenses suffer from common problems, which will be explained in detail below.

Considering the prior art in some detail, U.S. Pat. No. 4,693,572 discloses a lens commonly known as the “tangent streak” lens, in which the lens has a distance viewing region on the upper half of the lens, and a near-viewing portion on the bottom half of the lens. The distance and near-viewing portions are separated by a line extending directly across the lens in a straight line. The lens is “monocentric,” in that the centers of curvature of the interior surface of the lens, the exterior distance portion of the lens and the exterior near-vision portion of the lens all lie on a common optical axis line.

Referring to FIG. 1, a prior art bifocal contact lens generally designated 20 is illustrated. This lens 20 includes a rear surface of curvature 22, formed on radius R-1 and having a center of curvature C-1, a distant vision portion 24 and near vision portion or segment 26. The distant vision segment 24 has a front surface of curvature 28 formed on radius R-2 which has a center of curvature C-2, while the front surface 30 of the segment 26 has a radius of curvature R-3 and a center of curvature C-3.

As may be seen in FIGS. 1 and 2, the segment line area 33 separates the distant and near vision segments 24, 26, but this segment line provides a “shelf” surface 35 only away from the center of the segment or optical center, and the “shelf” surface 35 is of increasing thickness at the edges but virtually non-existent at the center of the lens.

The region of a contact lens 20 separating the distant vision portion from the near vision portion is a one-or-two part surface such as the surface 35 shown in FIGS. 2 and 3. This surface 35 extends between and joins the lower edge 34 of the distant vision surface 28 of the upper edge 36 of the lower or near vision segment surface 30.

As shown in FIG. 2, the lens as a whole has a radius R-4 with a center C-4, which for purposes of illustration, lies along the optical axis line 32. The construction of the lens of FIGS. 2 and 3 is such that the segment line area 33 approximately bisects lens 20. A shelf element 35 thus lies to either side of the geometric lens center C-4.

Referring to FIG. 3, a shelf surface 35 is fully developed only at the outer lateral edge, having some definition at an intermediate portion, and having no visible dimension whatever at or near the geometric center of the lens.

As is apparent from the illustrations of FIGS. 1, 2, and 3, where the front surface portion 30 of the near vision segment 26 exactly meets the distant vision front surface 28, there is no segment line or line of demarcation, since these surfaces meet, or are tangent to each other at a single point, and are nearly tangent at closely adjacent points.

However, below the shelf 35, the front surface 30 is of a decreased radius or steeper taper, and hence, the front surface lies radially inwardly of an imaginary spherical locus which would be formed by an extension or continuation of the lens distant vision front surface 28.

Turning now to a method of manufacturing the prior art lens described above, and considering FIG. 4, there is shown a lens blank 50, mounted on a post assembly 52 which includes a reduced diameter shank portion 54 and an enlarged diameter head portion 56 over which the cylindrical lens blank 50 is mounted. Referring to FIG. 5, it is shown that the lathe or like machine generally designated 58 includes a headstock spindle 60 having a collett chuck 62 therein which grasps the shank 54 of the post assembly 52. The machine headstock rotates about a machine axis 61 which normally forms the optical centerline axis of the lens blank 50.

As shown, the lens blank 50 includes a cylindrical outer surface portion 64, a flat front face portion 66, and a rear contoured surface 68. The lens blank 50 is first mounted in a suitable holder such as the head stock of a lathe (not shown) and rotated while the base curve 68 is cut and polished. The base curve 68 shown in FIG. 5 would correspond to the base curve 22 in the finished lens such as the lens shown in FIG. 1.

A certain base curve dimension is selected based on the anticipated fitting of the lens to the eye, and the curve 68 is then cut. Thereafter, the lens blank 50, having this surface 68 is affixed by a special pitch or like type adhesive 70 placed over the end face 72 of the post assembly. This secures the lens blank 50 for further cutting steps and permits ready removal of the lens from the fixture once it is finish ground. This method of affixation eliminates the need for grasping the lens mechanically as by a chuck or the like when it is receiving its finished cuts.

Referring now to FIG. 6, the lens blank 50 has an overall diameter “D”, the diameter of the surface 64 and twice the length of the radius R-4. A cutting tool generally designated 74 and shown to include a cutting tip 76, the position of which is adjustable by a thumb screw 78, which moves within a tool mounting or holder assembly 80 affixed to the end portion 82 of a tool mount assembly 84. The assembly 84 is pivotable about a post 86 which under ordinary circumstances is positioned so as to intersect the longitudinal center line 32 of the lens blank.

It is further shown in FIG. 6, the post 86 is secured in a carriage 87 or the like permitting it to move through a range of positions “P” for cutting lenses of various thicknesses. FIG. 6 shows that, when the lathe headstock 60 is rotated, and the thumbscrew 78 is manipulated so as to position the tool point 76, a given distance R2 from the center of the tool arm pivot 86, then such radius R-2 will be the radius of curvature of lens front surface portion. Having established this distance as by prescription or otherwise, the headstock is then rotated and the carriage 87 is moved throughout the position range “P” as shown, forming, for purposes of illustration, a series of cuts, K-1, K-2, K-3, etc. The corners of the blank are thus cut, first as shown in FIG. 6, and thereafter movement of the tool through the range of positions takes place as cutting continues.

Referring now to FIG. 7, with the distance R-2 remaining constant, the entire range of movement P has been taken up as shown in FIG. 7 and a spherical surface 28 has been imparted to the front surface of the lens blank 50; and uncut outer cylindrical edge 64 of a finite thickness remains, and the partially cut lens remains fixed to the enlarged head portion 56 of the post assembly 52.

Because of the concentric arrangements of parts and the rotation of the blank described in the swinging of the tool point through a circular arc, the surface 28 is, by definition, a spherical surface. FIG. 8 illustrates in perspective the movement of the tool post 86 as a part of a carriage mechanism 87 with such movement being carried out until the spherical surface segment 28 is formed as shown.

Further details regarding manufacture of the prior art lens discussed above may be found in U.S. Pat. No. 4,693,572.

Prior art lenses of this sort suffer from several disadvantages. One disadvantage arises because a contact lens typically rotates somewhat within the eye during normal use. With the tangent streak design, the line separating the distance from the near portions of the lens (known as a “segment line”) extends straight across the lens. When the lens rotates slightly, the segment line is oriented at an angle. When the user looks straight ahead, the eye looks through both near and distance portions of the lens. The user sees two images at once, resulting in “ghosting” of the image.

Another problem with the tangent streak design relates to the interaction between the segment line and the eyelid. There is a discontinuity along the segment line and, since the segment line extends straight across the lens, the eyelid tends to get caught on the segment line as the eye is opening. That is, as the upper eyelid travels from the lower portion of the lens when the eye is closed, to the upper portion of the lens when the eye is open, the eyelid catches on the segment line and pulls the lens up and out of position on the eye. Gravity eventually pulls the lens back down, but the vertical movement of the lens distorts the image that the user sees, and is uncomfortable.

Another problem with the tangent streak design relates to side peripheral vision. The tangent streak design provides similarly-sized near and distance portions. Consequently, when the user attempts to use his or her side peripheral vision for distance viewing (when driving, for example), the user sees a double image —one from the distance portion and one from the near portion of the lens. This is a potentially dangerous design flaw, and limits the situations in which the tangent streak lens can be used.

### SUMMARY OF THE INVENTION

The object of the present invention is to improve upon the prior art. In accordance with one aspect of the present invention, a monocentric bifocal contact lens for use on the cornea of an eye has a rear surface adapted to overlie the cornea of the eye in use. A front surface of the lens is subdivided into distant vision and near vision portions. The distant vision portion lies predominantly on the upper half of the lens, and the near vision portion lies predominantly on the lower half of the lens. The distant vision portion terminates in a segment line that extends in a generally upwardly-extending arc, with the apex of the arc pointing toward the upper portion of the lens and with the arc opening downwardly at the lower portion of the arc. The distant vision portion extends into left and right side portions of the lower half of the lens. Generally, the distance vision portion comprises a greater portion of the surface area than the near vision portion.

In accordance with another embodiment of the present invention, a monocentric bifocal contact lens for use on the cornea of an eye has a rear surface adapted to overlie the cornea of the eye in use. The rear surface typically has a substantially constant radius of curvature. The lens has a front surface that is subdivided into distant vision and near vision portions. The major portion of the lens is defined by upper and lower circles of substantially equal diameter, the respective centers of each of the two circles lying along a common vertical line. An upper portion of the lower circle overlaps a lower portion of the upper circle, with the near-vision portion of the lens being substantially defined by the overlapping portion of the two circles. The lower circle has an upper edge that extends upwardly along the lens to a point no more than one-half the diameter of the upper circle. The near vision portion of the lens extends entirely within the lower half of the lens and occupies less than one-half the surface area of the lens.

In accordance with another embodiment of the present invention, a monocentric bifocal contact lens for use on the cornea of an eye has a rear surface adapted to overlie the cornea of the eye in use. The rear surface has a substantially constant radius of curvature. The front surface of the lens is subdivided into distant vision and near vision portions. The major portion of the lens is defined by upper and lower circles of substantially equal diameter, the respective centers of each of the two circles lying along a common vertical line. An upper portion of the lower circle overlaps a lower portion of the upper circle, the near-vision portion of the lens being substantially defined by the overlapping portion of the two circles. The lower circle has an upper edge that extends upwardly along the lens to a point no more than one-half the diameter of the upper circle, such that the near vision portion of the lens extends entirely within the lower half of the lens and occupies less than one-half the surface area of the lens. The lens has prism, with the center of the prism being offset from the bottom center of the lens to provide a counterweight to rotation of the lens within the eye. The segment height is typically less than the radius of the lens, and the ratio of surface area of the distance portion of the lens to the surface area of the near portion of the lens is at least 2 to 1. The lens has a transition ring that extends about at least a portion of the periphery of the bottom half of the lens. It should be noted that various individual features of this particular embodiment may be incorporated into other embodiments of the lens, as desired. dr

Further objects and features of the present invention will become apparent from a review of the detailed description, the drawings, and the claims.

### BRIEF DESCRIPTION OF DRAWINGS

FIG. 1 is a side elevational view of a prior art tangent streak lens;

FIG. 2 is a front elevational view of the prior art lens of FIG. 1;

FIG. 3 is a is a vertical section view taken along line 3-3 of FIG. 2;

FIG. 4 is a perspective view of a “button” from which a finished lens may be cut;

FIG. 5 is an elevational view showing the lens blank with the base curve completed, before beginning the first step in cutting the prior art lens;

FIG. 6 is a diagrammatic view similar to that of FIG. 5 showing the first and several intermediate stages of the first step in forming the front surface of the prior art lens;

FIG. 7 shows completion of the first step of in the manufacture of the prior art lens;

FIG. 8 further illustrates a method of manufacturing the prior art lens;

FIG. 9 is a front view of novel bifocal contact lens design according to the present invention;

FIG. 10 illustrates design details of one embodiment of the present invention; and

FIGS. 11-15 are cross-sectional views taken along Line 11 in FIG. 9 illustrating the changing profile of the lens as it is manufactured.

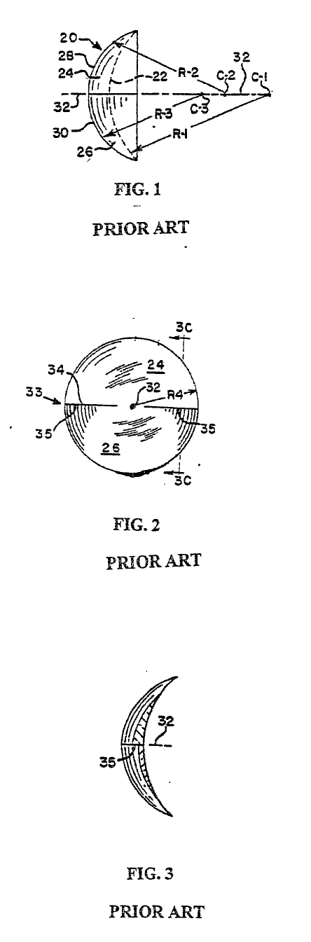

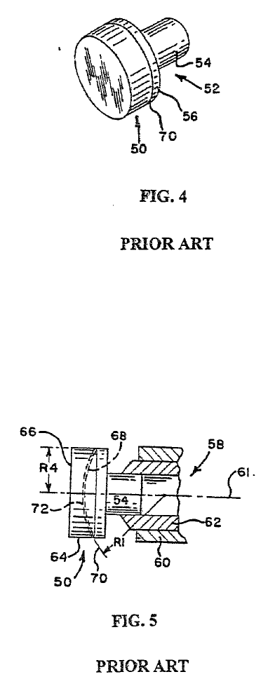

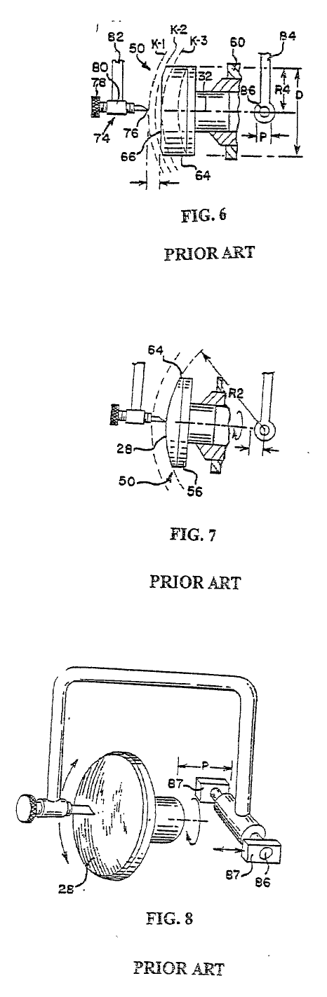

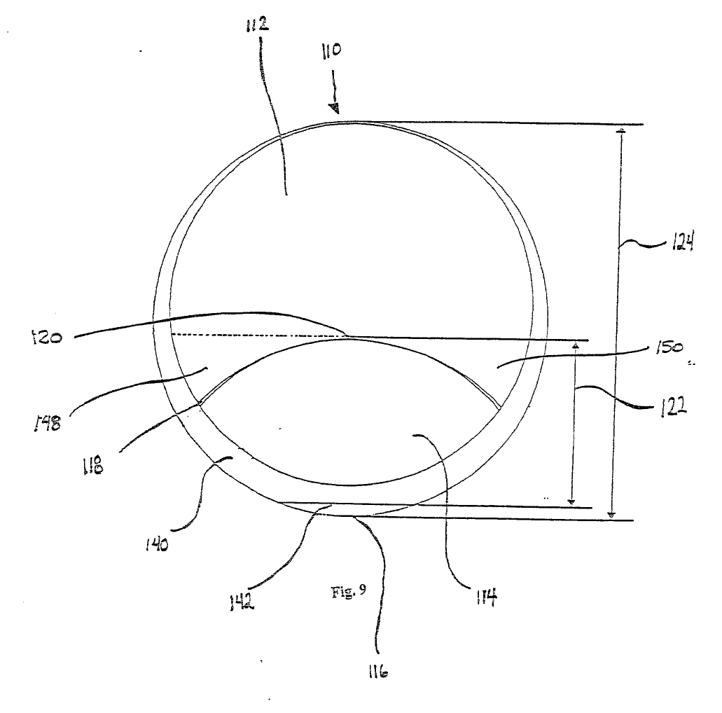

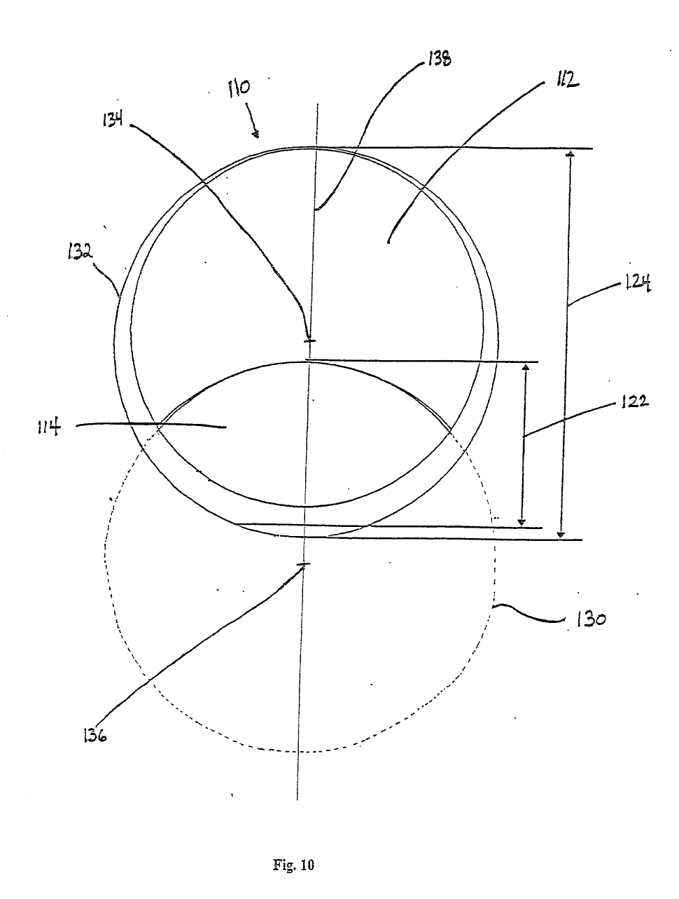

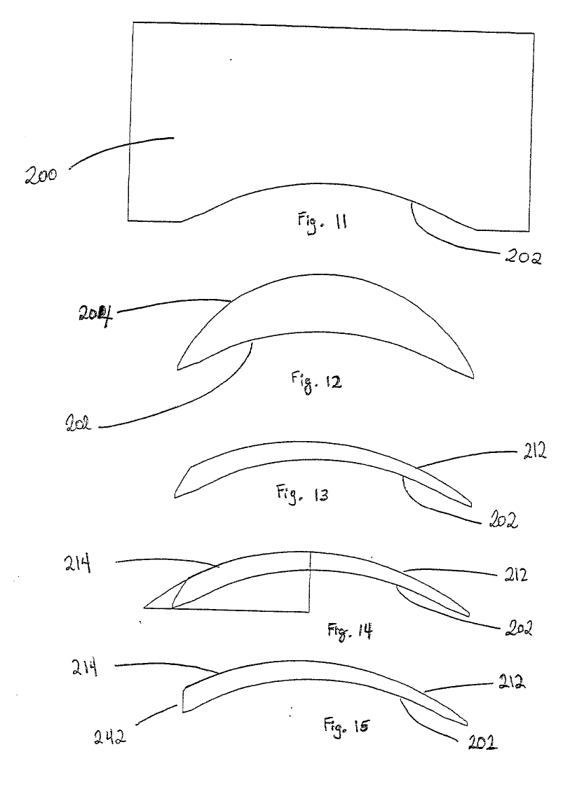

### DETAILED DESCRIPTION OF THE PREFERRED EMBODIMENT

Referring now to FIG. 9, an improved monocentric bifocal contact lens 110 for use on the cornea of an eye has a standard spherical rear surface (not shown) that is adapted to overlie the cornea of the eye. As is known in the art, the rear surface is typically spherical, with a constant radius of curvature in both the horizontal and vertical planes.

FIG. 9 illustrates the front surface of the lens, which in the preferred embodiment is generally spherical. The front surface is subdivided into a distant vision portion 112 and a near vision portion 114. The distant vision portion 112 has a radius of curvature that is less than the radius of curvature of the near vision portion 114. The specific radii of curvature will vary from user to user, and most commonly an optometrist prescribes the radii of curvature to the manufacturer when ordering the lenses for a particular patient.

The lens has prism (not shown), with the center of the prism base being offset from the bottom center of the lens 116. The offset is typically within about 10 degrees of the bottom center 116. The purpose for this prism offset lies with the tendency of the lens to rotate within the eye. The prism base is located a few degrees from the bottom center of the lens in order to provide a counterweight to act against the tendency of the lens to rotate. The left and right lenses normally rotate in opposite directions. Consequently, the prism base is offset in opposite directions in the left and right lenses, respectively.

The distant vision portion 112 and the near vision portion 114 are separated at a segment line 118. The segment line 118 preferably follows a portion of the perimeter of a circle, although the segment line may alternatively be elliptical, parabolic or have another geometry other than circular. The distance from the bottom center of the lens 116 to the apex 120 of the segment line 118 is known as the segment height 122. The segment height is typically less than one-half of the diameter 124 of the lens, such that the near vision portion of the lens is entirely within the bottom half of the lens.

Referring now to FIG. 10, the near vision portion of the lens 114 is a portion of a circle 130. The major portion of the lens is defined by an upper circle 132 and lower circle 130, both of which have substantially equal diameter. The respective centers 134 and 136 of the two circles lie along a common vertical line 138. An upper portion of the lower circle overlaps a lower portion of the upper circle, the near-vision portion 114 being substantially defined by the overlapping portion of the two circles.

The lower circle 130 has an upper edge that extends upwardly along the lens to a point 120 that is typically no more than one-half the diameter of the upper circle 132, although on some patients the lower circle might be higher. The near vision portion 114 of the lens extends entirely within the lower half of the lens and occupies less than one-half the surface area of the lens. The ratio of the surface area of the distance portion of the lens to the surface area of the near portion of the lens is preferably at least 2 to 1, such that the lens has a much larger distant vision portion 112 than near vision portion 114. However, in particular embodiments of the lens, the ratio of distant to near-vision portions of the lens may be different.

Returning to FIG. 9, the preferred lens 110 has a transition ring 140 that extends about the periphery of the lens. The transition ring 140 represents an area of the lens with a relatively small radius of curvature that provides a smooth transition for the eye at the edges of the lens. In the preferred embodiment, the transition ring 140 is relatively wide at the bottom of the lens, and is relatively narrow at the top of the lens. The lens may optionally be truncated at the bottom of the lens along truncation line 142.

The presently preferred embodiment of the present invention offers a number of benefits over the prior art tangent streak design. As seen in FIG. 9, the segment line 118 extends in a downward frown. A problem with the tangent streak design is that when the lens rotates within the eye slightly, the tangent line cuts diagonally across the user's eye. Vision is distorted, because the eye sees partially out of the distance portion of the lens (which extends below the center of the lens on one side of the lens) and partially out of the near vision portion of the lens (which extends above the center of the lens on the opposite side of the lens).

On the other hand, in the preferred embodiment of the present design, the lens can rotate slightly in either direction without causing the near vision portion of the lens to extend into the upper half of the lens. Distance portion segments 148 and 150 extend downwardly on the lens to either side of the apex 120 of the near vision portion 114. The distance portion segments may be thought of as rotation buffer zones, that permit the lens to rotate slightly while maintaining the near vision portion in the lower half of the lens. These rotation buffer zones reduce vision distortion that arises as a result of normal rotation of the lens.

A second advantage of the preferred embodiment is that the gradual curve of the segment line makes it easier for the user to blink. With the tangent streak design, the eyelid tends to catch on the straight segment line as the eyelid is going from a closed position to an open position. The eyelid tends to catch on the entire segment line all at once, since the segment line extends straight across the lens. The result is that the lens tends to lift up when the user blinks. Although the lens then settles back into place, the user experiences some discomfort as the lens continually lifts up off of the eye.

With the present invention, however, the eyelid encounters the segment line gradually, rather than all at once. Consequently, the tendency of the lens to lift off of the eye is greatly reduced, and the lens is more comfortable to wear.

A further advantage of the preferred embodiment over the tangent streak design is that the distance vision portion of the lens is increased in area in the present design. The lens is therefore better suited to a range of activities that require distance viewing, such as driving and sports, where good peripheral distance vision is important. In the preferred embodiment of the present design, the near view portion of the lens is predominantly directly below the central region of the lens. Most readers, for example, look generally down from the center of the lens when reading, but do not look out the sides of the lens to read. By locating the near vision portion of the lens where the user is most likely to look when reading, the lens provides an adequate near vision area, but greatly improves the functionality of the lens for distance viewing.

Turning now to the method of manufacturing the lens, the lens is typically cut in separate stages. In the first stage, a button 200 (FIG. 11, which is a cross-sectional representation of the button) is rotated (as illustrated in FIG. 7). The button has a portion 202 that will ultimately rest against the eye of the user. A sharp diamond cuts the button with a constant radius of curvature to form a base curve 204 (FIG. 12). A flange radius may also cut about the edge of the button. The surface may also be polished at this stage.

The cut button is then transferred to another machine in which the diamond, rather than the button, rotates at high speed in order to cut the button. One commercially available contact lens lathe suitable for this purpose is the DAC Vision Compact Four Axis Lens Lathe, Series III/4XC, which is available from DAC Vision of Carpinteria, Calif. Although the button does not rotate in this step, the button can be moved back and forth, up and down, and tilted at an angle relative to the diamond in order to cut desired patterns onto the lens.

A suitable accessory for use with the DAC Series III/4XC lathe is the front curve toric tool, also available from DAC. The diamond is offset from the center of the tool, such that the diamond rotates in a circle as the lathe rotates the tool. It is noted that modified tools may be used, if desired, and it is expected that one skilled in the art will make modifications to the tools as necessary for particular lens designs.

Using the Series III/4XC lathe, the distance curve 212 is first cut. (FIG. 13). The diamond position is then adjusted in preparation for cutting the near vision curve. Because the diamond is rotating in a circle, the relative angle between the rotating diamond and the front surface of the lens can be adjusted so as to cut the near vision portion 114 of the lens as depicted in FIG. 9, for example. FIG. 14 is a cross-sectional view of the lens after the near curve portion 214 of the lens has been cut. Once the near vision portion 114 is cut, the user may then truncate the lens, if desired, using any of the known methods for truncating lenses, such as filing, or with a lathe or other machine. FIG. 15 illustrates the cross-section of the lens as it has been cut and truncated, with the truncated portion being represented at reference numeral 242.

By using the same rotating diamond to cut both the near and distance portions of the lens, the manufacturer is able to maintain close control over the location of the optical center of the lens. In the preferred embodiment, the lens is monocentric. Consequently, the manufacturer may use the rotating diamond lathe, which may also be known as a “flycutter” lathe, to maintain the monocentricity of the lens during the cutting process.

The combination of the monocentricity of the lens and the downwardly-curving “frown” segment line between the distance and near vision portion results in a particularly advantageous lens. In particular, the lens eliminates the “jump” that the user often experiences when shifting vision from a distant object to a near object, or vice versa. Because the optical centers of the near vision and distant vision portions all lie on a common optical axis line, the user may switch between near and distant vision with a smooth transition. Furthermore, because of the geometry of the downward “frown” of the segment line, the eyelid does not catch on the shelf on the outer edges of the segment line.

Also, the downward frown allows the lens to rotate slightly on a blink without changing the user's vision from near to distant vision, or vice versa. With the tangent streak design, if the user is looking through the distant vision portion of the lens, for example, and then blinks, the lens can rotate in the eye. Part of the near vision portion of the lens can thus rotate up into an area where the eye had been looking out of a distant vision portion of the lens, causing momentary blurring until the lens rotates back into proper position. The downward frown transition zone of the present invention, however, allows the lens to rotate slightly in the eye without disrupting vision.

Although the foregoing has described a presently preferred embodiment of the present invention, various modifications to the design may be made within the scope of the invention. Thus, for example, the segment line 118 need not be circular, but could have another shape, such as elliptical or parabolic, although the method of manufacture will need to be adjusted accordingly. Multi-focal lenses having, for example, a distance viewing zone, an intermediate viewing zone, and a near viewing zone, can be constructed with a near viewing zone of the sort described herein. The intermediate viewing zone will typically be located in between the distance viewing and near viewing portions of the lens, with one segment line separating the intermediate viewing and distance viewing portions of the lens. A second segment line would separate the near and intermediate viewing portions of the lens, the second segment line having a profile such as segment line 118 in FIG. 9.

As another alternative, the near portion of the lens can be cut first, and then the distance portion, if desired. The lens may also be truncated first, prior to the near and distance portions being cut. Consequently, the invention is not limited to the preferred embodiment.

1. A bifocal contact lens for use on the cornea of an eye, comprising:
a rear surface adapted to overlie the cornea of the eye in use, said rear surface having a substantially constant radius of curvature; and
a front surface that is subdivided into distant vision and near vision portions, said front surface having a surface area;
wherein the major portion of the lens is defined by upper and lower circles of substantially equal diameter, the respective centers of each of the two circles lying along a common vertical line, an upper portion of the lower circle overlapping a lower portion of the upper circle, the near-vision portion of the lens being substantially defined by the overlapping portion of the two circles, the lower circle having an upper edge that extends upwardly along the lens to a point no more than one-half the diameter of the upper circle, such that the near vision portion of the lens extends entirely within the lower half of the lens and occupies less than one-half the surface area of the lens;
and wherein said lens is monocentric.

2. A bifocal contact lens as defined in claim 1 wherein the lens has prism, with the center of the prism being offset from the bottom center of the lens.

3. A bifocal contact lens as defined in claim 1 wherein the segment height is less than the radius of the lens.

4. A bifocal contact lens as defined in claim 1 wherein the lens is tapered along at least the lower portion of the lens.

5. A bifocal contact lens as defined in claim 11 wherein a transition ring extends about at least the periphery of the lower portion of the lens.

6. A bifocal contact lens as defined in claim 1 wherein the ratio of surface area of the distance portion of the lens to the surface area of the near portion of the lens is at least 2 to 1.

7. A bifocal contact lens for use on the cornea of an eye, comprising:
a rear surface adapted to overlie the cornea of the eye in use;
a front surface that is subdivided into distant vision and near vision portions, said front surface having a surface area;
said distant vision portion lying predominantly on the upper half of the lens, said near vision portion lying predominantly on the lower half of the lens;
said distant vision portion terminating in a segment line which extends in a generally upwardly-extending arc, with the apex of the arc pointing toward the upper portion of the lens and with said arc opening downwardly at the lower portion of the arc, with the segment line separating the distant and near vision portions of the lens;
said distance portion extending into left and right side portions of the lower half of the lens; and
said distance vision portion comprising a greater portion of said surface area than said near vision portion;
wherein said lens is monocentric.

8. A bifocal contact lens as defined in claim 7 wherein said arc is circular.

9. A bifocal contact lens as defined in claim 7 wherein the ratio of surface area of the distance portion of the lens to the surface area of the near portion of the lens is at least 2 to 1.

10. A bifocal contact lens as defined in claim 7 wherein the lens has prism, with the center of the prism being offset from the bottom center of the lens.

11. A bifocal contact lens as defined in claim 7 wherein the segment height is less than the radius of the lens.

12. A bifocal contact lens as defined in claim 7 wherein the lens is tapered along at least the lower portion of the lens.

13. A bifocal contact lens as defined in claim 7 wherein a transition ring extends about at least the lower portion of the periphery of the lens.

14. A bifocal contact lens for use on the cornea of an eye, comprising:
a rear surface adapted to overlie the cornea of the eye in use, said rear surface having a substantially constant radius of curvature; and
a front surface that is subdivided into distant vision and near vision portions, said front surface having a surface area;
wherein the major portion of the lens is defined by upper and lower circles of substantially equal diameter, the respective centers of each of the two circles lying along a common vertical line, an upper portion of the lower circle overlapping a lower portion of the upper circle, the near-vision portion of the lens being substantially defined by the overlapping portion of the two circles, the lower circle having an upper edge that extends upwardly along the lens to a point no more than one-half the diameter of the upper circle, such that the near vision portion of the lens extends entirely within the lower half of the lens and occupies less than one-half the surface area of the lens;
said lens having prism, with the center of the prism being offset from the bottom center of the lens to provide a counterweight;
the segment height being less than the radius of the lens;
the lens having a transition ring that extends about at least a portion of the periphery of the bottom half of the lens; and
the ratio of surface area of the distance portion of the lens to the surface area of the near portion of the lens being at least 2 to 1;
wherein said lens is monocentric.
